(19) United States
(12) Patent Application Publication
(10) Pub. No.: US 2008/0066246 A1
(43) Pub. Date: Mar. 20, 2008

(54) Cleaning tool for a hearing device

(76) Inventors: Markus Hornig, Pinzberg (DE); Harald Klemenz, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/900,890

(22) Filed: Sep. 13, 2007

(30) Foreign Application Priority Data
Sep. 14, 2006 (DE) 10 2006 043 153.7

(51) Int. Cl. B08B 1/00

(52) U.S. Cl. 15/104.16

(57) ABSTRACT

The invention relates to a cleaning tool for a hearing device, with which a cerumen protector can be replaced in an opening of a hearing device and cerumen residues can be cleaned from the opening. To this end the cleaning tool has means for inserting a cerumen protector into an opening of the hearing device provided for this purpose, means for removing the cerumen protector from the opening and means for removing cerumen from the opening.

### CROSS REFERENCE TO RELATED APPLICATIONS

This application claims priority of German application No. 10 2006 043 153.7 filed Sep. 14, 2006, which is incorporated by reference herein in its entirety.

### FIELD OF THE INVENTION

The invention relates to a cleaning tool for a hearing device, with which a cerumen protector can be applied into a hearing device and removed again therefrom. The invention also relates to a kit, having the inventive cleaning tool and a container to hold used cerumen protectors.

### BACKGROUND OF THE INVENTION

The acoustic output signal of a hearing device is typically routed by way of a channel or tube into the auditory canal. The tube or channel is regularly contaminated by cerumen in this process. To eliminate this problem numerous cerumen protection devices are known in the field, which are intended to prevent the penetration of cerumen into the tube or channel of the hearing device. These cerumen protection devices do not however provide a complete seal so over time cerumen can still pass into the opening of the hearing device. For this reason and also because the cerumen protector can also be damaged, it is necessary to replace the cerumen protector from time to time. The unexamined patent application WO 00/03561 describes such a cerumen protection system and an associated application tool for removing a used cerumen protector and applying a new cerumen protector. The cerumen protector is introduced in an opening of an acoustic output channel or an opening in the hearing device housing and consists essentially of a tubular element, which is tailored to the opening and has a barrier for retaining cerumen. The associated application tool is a rod-shaped tool with a pin for applying a new cerumen protector at one end and a latching element to latch with a used cerumen protector for subsequent removal.

Despite the use of a cerumen protector cerumen can still pass into the opening. This cerumen can dry thereon and is difficult to remove. Simply replacing the cerumen protector does not have a cleaning effect. The cerumen in the opening of the hearing device increases the probability of infection and is therefore not acceptable for hygiene and cosmetic reasons.

### SUMMARY OF THE INVENTION

The object of the present invention is therefore to create a cleaning tool, which allows both the replacing of the cerumen protector and the cleaning of the opening of the hearing device. The cleaning tool should be as simple as possible to operate, so that it can be used easily, even by elderly hearing device wearers for example.

According to the invention the object is achieved by a cleaning tool and a kit as claimed in the claims.

The inventive cleaning tool has the following features:
a) Means for inserting a cerumen protector into an opening of the hearing device provided for this purpose;
b) Means for removing the cerumen protector from the opening; and
c) Means for removing cerumen from the opening.

The means for inserting the cerumen protector preferably has a holder for an (unused) cerumen protector. The means for inserting the cerumen protector can for example be configured as an essentially cylindrical or pin-type projection, on which a cerumen protector can be held.

The means for removing the cerumen protector can have a hook, a latching element or another non-slip connection, to grip the used cerumen protector located in the opening or to latch with it. In the case of a cerumen protector provided with a membrane or cover, it is also possible to provide a means for removing the cerumen protector, which can push through the membrane or cover, with the used cerumen protector being destroyed during removal as a result.

According to a further preferred aspect of the invention the means for removing the cerumen protector is attached to the cleaning tool in a detachable manner. It can be attached to the cleaning tool for example by means of a latching connection (e.g. pushed onto a pin). According to a preferred aspect of the present invention the means for removing the cerumen protector is attached to the cleaning tool by means of a rupture point so that it can be broken off.

The means for removing cerumen from the opening preferably has a cleaning element that can be introduced into the opening of the hearing device, said cleaning element preferably being able to have a scraping edge or other cleaning unit for removing cerumen from the opening. Alternatively the cleaning element could also be configured in the manner of a brush. Frequently the opening of the hearing device, in which the cerumen protector is held, has a somewhat larger diameter than the hearing tube or sound channel, through which the acoustic signal leaves the hearing device. To prevent cerumen passing into the sound channel during cleaning, it is preferable for a pin or similar element to be provided on the cleaning element that can be introduced into the opening, said pin or similar element being inserted into the opening of the sound channel during cleaning. This prevents cerumen being able to pass into the opening of the sound channel during cleaning. The pin can be dimensioned in such a manner that it is positioned in a rotatable manner in the smaller opening of the sound channel when the cleaning element is introduced into the opening of the hearing device, in which the cerumen protector is held, so that cleaning can be effected by means of a rotational movement of the cleaning tool in relation to the hearing device, with cerumen being detached from the opening provided to hold the cerumen protector using the scraping edge provided, so that it can be removed.

According to a preferred embodiment of the present invention the means for removing the cerumen protector is attached to the cleaning element of the cleaning tool by means of a rupture point so that it can be broken off.

According to a further preferred aspect of the present invention the cleaning tool has a plurality of arms, at the ends of which the means for inserting the cerumen protector and/or the means for removing the cerumen protector and/or the means for removing cerumen are provided.

The cleaning tool preferably has three arms, which are disposed in a T or Y shape.

The invention also relates to a kit, which comprises an inventive cleaning tool and a container, which has at least one compartment to hold used cerumen protectors. The container can also preferably have a further compartment with a supply of unused cerumen protectors. The first compartment preferably has an opening, which is configured so that the means for removing the cerumen protector can be separated in an interaction with the opening.

### BRIEF DESCRIPTION OF THE DRAWINGS

Further features and advantages of the present invention will emerge from the following exemplary embodiments and the accompanying drawings, in which:

FIG. 1 shows a top view of a first embodiment of the inventive cleaning tool;

FIG. 2 shows a top view of a second embodiment of the inventive cleaning tool;

FIG. 3 shows a top view of a third embodiment of the inventive cleaning tool; and

FIG. 4 shows a perspective view of a container, which forms part of the inventive kit.

### DETAILED DESCRIPTION OF THE INVENTION

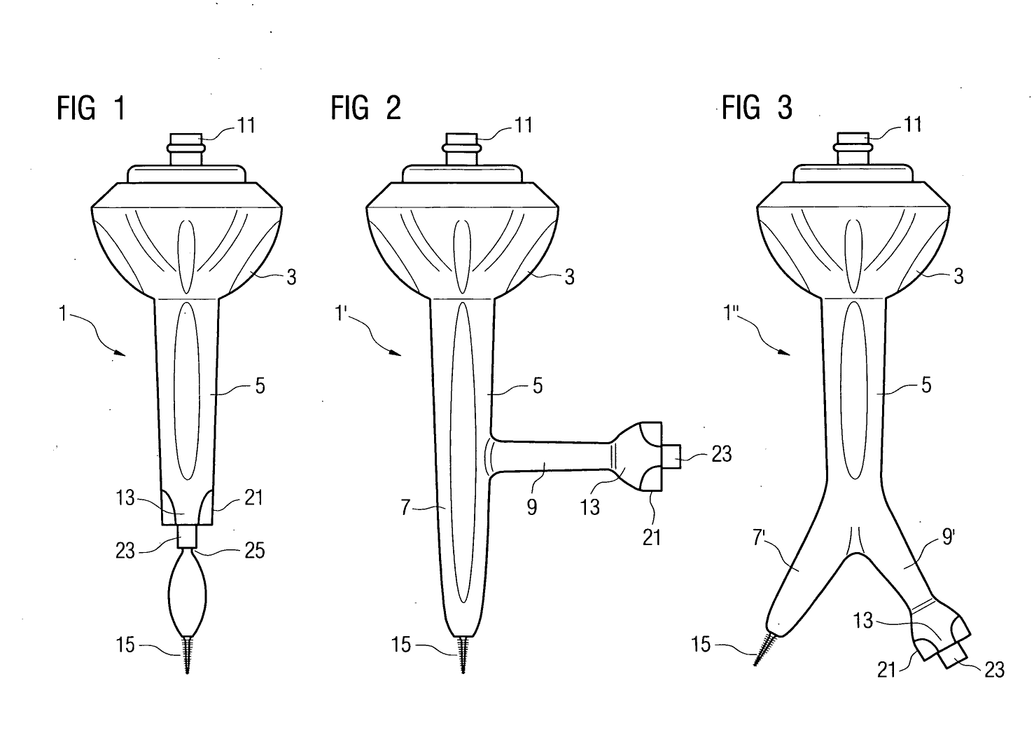

FIG. 1 shows an embodiment of the inventive cleaning tool 1, having a gripping knob 3 and an elongated main part 5. Located at a first end are a holder and fixing unit for a cerumen protector 11, e.g. in the form of a cylindrical projection 11, which serves as a means for inserting a cerumen protector into an opening of the hearing device provided for this purpose. An unused cerumen protector can be attached to the cylindrical projection 11 and then be applied with the aid of the tool in the opening of the hearing device. Located at a second end of the cleaning tool 1 is a mandrel 15 with a grooved structure, which serves as a means for removing a used cerumen protector from the opening. During use the covering membrane or protection element of the cerumen protector is pierced with the mandrel and the cerumen protector can then be removed using the tool. The mandrel is on a support, which is connected by way of a rupture point 25 to the cleaning tool 1. Once the used cerumen protector has been removed, the mandrel, on which the used cerumen protector is “speared” can be broken off by a simple snapping action. This causes the cleaning element 13, which serves to clean the opening, to be released. Located on the outer end of the cleaning element 13 is a stud or pin 23, which has a smaller diameter than the cleaning element 13 and the main part 5 of the cleaning tool 1. When the cleaning element 13 is inserted into the opening of the hearing device holding the cerumen protector, the stud 23 is introduced into the sound channel of the hearing device, which has a smaller diameter than the opening for holding the cerumen protector. This allows the stud to be rotated freely in the opening of the sound channel and to seal off the sound channel opening while the opening of the hearing device provided to hold the cerumen protector is being cleaned. Scraping edges 21 are provided on the cleaning element 13, which scrape along the base and walls of the opening, as the cleaning tool is being rotated in said opening, to detach cerumen residues. By rotating the hearing device so that the opening faces downward, removing the cleaning tool and in some instances shaking the hearing device, it is possible to remove the detached cerumen residues from the opening intended to hold the cerumen protector. The holder 11 of the cleaning tool 1 can then be used to introduce a new cerumen protector into the opening provided on the hearing device for this purpose. The cleaning tool shown in the present embodiment in FIG. 1 is intended for single use.

FIG. 2 shows an alternative embodiment 1′ of the inventive cleaning tool. This embodiment is configured as a T-shaped tool, with the main part 5 being lengthened by means of an arm 7, on which the mandrel 15 for removing the used cerumen protector is located. A further arm 9 is disposed essentially perpendicular to this, with the cleaning element 13 with stud 23 and scraping edges 21 located on its end. The mode of operation corresponds to that of the cleaning tool shown in FIG. 1, except that the means for removing the used cerumen protector does not have to be broken off. After use the used cerumen protector can be left on the mandrel if the cleaning tool is only to be used once. Alternatively the used cerumen protector can be removed manually for example from the mandrel 15, so that the cleaning tool 1′ can be used again.

FIG. 3 shows a third embodiment 1″ of the inventive cleaning tool. This cleaning device 1″ has two arms 7′, 9′ disposed in a Y-shape on its main part 5. Located on their respective ends are the mandrel 15 for removing the used cerumen protector and the cleaning element 13 with scraping edges 21 and stud 23 for cleaning the opening, which serves to hold the cerumen protector.

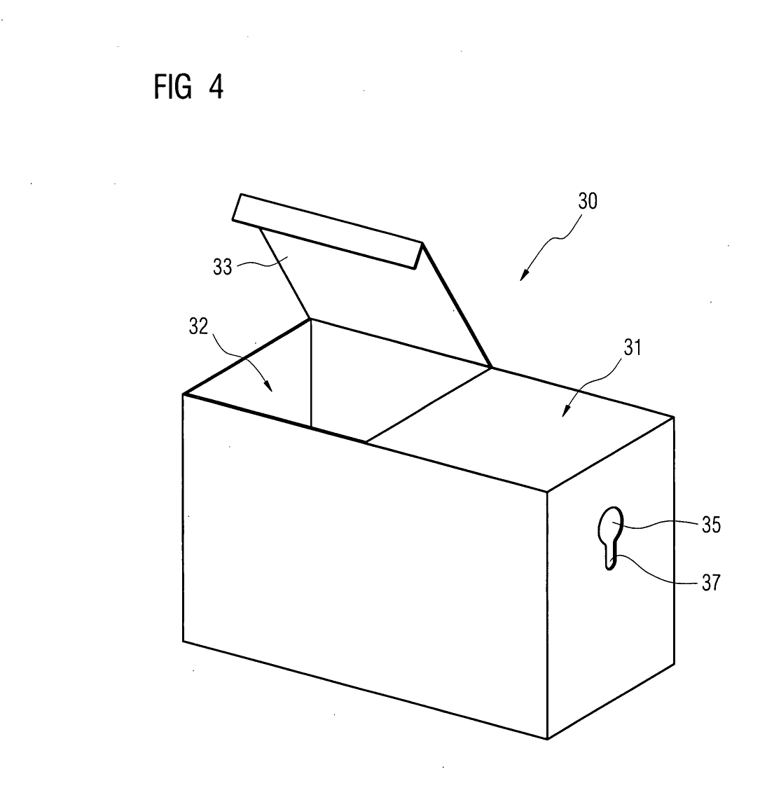

FIG. 4 shows a container 30, which is provided to hold used cerumen protectors. The container 30 has a first compartment 31 for holding used cerumen protectors and a second compartment 32 for storing unused cerumen protectors. The container 30 can be made of cardboard or a similar suitable material. The compartment 32 has a lid 33. In the compartment is an opening 35, made in the side of the container. The opening 35 is essentially circular and has a tapering extension 37, in which the used cerumen protector can be pulled away from the mandrel, so that a used cerumen protector or (for example if there is a corresponding rupture point) the entire mandrel with the used cerumen protector can be separated from the cleaning tool and can drop into the container 30.

It is emphasized that the embodiments illustrated are only examples and other configurations and arrangements are also possible with regard to the arrangement of the means for removing the cerumen protector, cleaning the opening and attaching a new cerumen protector.

1.-12. (canceled)

13. A cleaning tool for a hearing device, comprising:
a first device that inserts a cerumen protector into an opening of the hearing device;
a second device that removes the cerumen protector from the opening; and
a third device that removes a cerumen from the opening.

14. The cleaning tool as claimed in claim 13, wherein the first device comprises a holder for holding the cerumen protector.

15. The cleaning tool as claimed in claim 14, wherein the holder is essentially cylindrical.

16. The cleaning tool as claimed in claim 13, wherein the second device comprises a latching element or a non-slip element for latching or connecting to the cerumen protector.

17. The cleaning tool as claimed in claim 13, wherein the second device is detachablely attached to the cleaning tool.

18. The cleaning tool as claimed in claim 17, wherein the second device is attached to the cleaning tool by a rupture point to be broken off.

19. The cleaning tool as claimed in claim 13, wherein the third device comprises a cleaning element with a scraping edge that can be introduced into the opening.

20. The cleaning tool as claimed in claim 13, wherein the cleaning tool comprises a plurality of arms for holding the first device, or the second device, or the third device on an end of one of the arms.

21. The cleaning tool as claimed in claim 20, wherein the cleaning tool comprises three arms that are disposed in a T or Y shape.

22. A kit for cleaning a hearing device, comprising:
a cleaning tool that comprises:
a first device that inserts a cerumen protector into an opening of the hearing device,
a second device that removes the cerumen protector from the opening, and
a third device that removes a cerumen from the opening; and
a container with a compartment that holds the removed cerumen protector.

23. The kit as claimed in claim 22, wherein the container comprises a further compartment that holds an unused cerumen protector.

24. The kit as claimed in claim 22, wherein the compartment comprises an opening for separating the removed cerumen protector or the third device from the cleaning tool.

25. The kit as claimed in claim 22, wherein the first device comprises a holder for holding the cerumen protector.

26. The kit as claimed in claim 25, wherein the holder is essentially cylindrical.

27. The kit as claimed in claim 22, wherein the second device comprises a latching element or a non-slip element for latching or connecting to the cerumen protector.

28. The kit as claimed in claim 22, wherein the second device is detachablely attached to the cleaning tool.

29. The kit as claimed in claim 28, wherein the second device is attached to the cleaning tool by a rupture point to be broken off.

30. The kit as claimed in claim 22, wherein the third device comprises a cleaning element with a scraping edge that can be introduced into the opening.

31. The kit as claimed in claim 22, wherein the cleaning tool comprises a plurality of arms for holding the first device, or the second device, or the third device on an end of one of the arms.

32. The kit as claimed in claim 31, wherein the cleaning tool comprises three arms that are disposed in a T or Y shape.
